(19) United States
(12) Patent Application Publication
(10) Pub. No.: US 2003/0100288 A1
(43) Pub. Date: May 29, 2003

(54) Universal PLC radio frequency enhanced bridge

(75) Inventors: Harold Woodruff Tomlinson JR., Scotia, NY (US); Michael James Hartman, Clifton Park, NY (US); John Erik Hershey, Ballston Lake, NY (US); Scott Charles Evans, Burnt Hills, NY (US); Ralph Thomas Hoctor, Saratoga Springs, NY (US); David Michael Davenport, Niskayuna, NY (US); John Anderson Fergus Ross, Del Mar, CA (US)

Correspondence Address: GENERAL ELECTRIC COMPANY, GLOBAL RESEARCH CENTER, PATENT DOCKET RM. 4A59, PO BOX 8, BLDG. K-1 ROSS, NISKAYUNA, NY, 12309, US

(73) Assignee: General Electric Company One Research Circle, Niskayuna, NY

(21) Appl. No.: 09/683,178

(22) Filed: Nov. 29, 2001

(51) Int. Cl. H04M 9/00; H04Q 7/20; H04M 11/00; H04M 1/00; H04B 1/38

(52) U.S. Cl. 455/402; 455/550; 455/561

(57) ABSTRACT

A dual transceiver enhanced bridge is provided for wirelessly radio frequency (RF) broadcasting messages received on a power line communication system. The dual transceiver enhanced bridge includes a power line carrier (PLC) modem connected to the power line by a connecting plug. The PLC modem is connected to a memory unit. The dual transceiver enhanced bridge also comprises an RF modem connected to the memory unit. A controller is connected to the PLC modem, the RF modem, and the memory unit to control transmission of messages from the connected devices.

### BACKGROUND OF INVENTION

The present invention relates to a communication system, and more particularly, to a communication system providing an enhanced bridge between a power line communications (PLC) system and a radio frequency (RF) communications system.

When locating radio frequency (RF) communications systems within a building, several obstacles are encountered, such as, blindspots that include areas within the building where RF communications signals do not penetrate adequately from a single transmitter location. In addition, mobile transmitters can be moved into these blindspots and be unable to reach a fixed RF receiver point. The installation of multiple fixed RF modems to service and provide communications to multiple mobile RF units is one possible way to overcome problems relating to blindspots and other problems. However, a plurality of fixed RF modems that are dispersed through a building requires a relatively large communications infrastructure to carry messages to and from the fixed RF modems to a centralized communications location. The installation of special wiring may be costly and difficult to install particularly within a building that is serving dynamic and time critical needs such as a hospital. Therefore, a desire exists to develop communications systems that are capable of providing a communications infrastructure to a plurality of fixed RF modems within a building without the aforementioned deficiencies.

### SUMMARY OF INVENTION

In one embodiment, a dual transceiver enhanced bridge is provided for communicating RF messages from a radio frequency (RF) communication system and power line communication (PLC) messages from a power line communication (PLC) system. The radio frequency (RF) communication system includes a plurality of RF transmitting and receiving units. The dual transceiver enhanced bridge comprises a PLC modem connected to a power line. The PLC messages are transmitted on and received from the power line using the PLC modem on the PLC communication system. In addition, the PLC modem converts PLC messages received from the power line to predetermined format messages. An RF modem is connected to the PLC modem. The RF modem converts RF messages received from the plurality of RF transmitting and receiving units on the RF communication system. Also, the RF modem converts the RF messages to predetermined format messages. Additionally, the PLC modem converts predetermined format messages received from the RF modem to PLC messages before transmission over the power line, and the RF modem converts the predetermined format messages received from the PLC modem to RF messages before transmission over the RF communication system. A memory unit is connected between the PLC modem and the RF modem. The memory unit stores predetermined format messages received from the PLC modem and the RF modem. A controller is connected to the PLC modem, the RF modem, and the memory unit. The controller controls the transfer the predetermined format messages between the memory unit to the RF modem and the PLC modem.

In another embodiment, a method for communicating RF messages from a radio frequency (RF) communication system and power line communication (PLC) messages from a power line communication (PLC) system. The radio frequency (RF) communication system includes including a plurality of RF transmitting and receiving units. The method comprises the steps of connecting a PLC modem connected to a power line. The PLC modem receives the PLC messages from the power line via the PLC system. The PLC messages received from the PLC communication system are converted to predetermined format messages using the PLC modem. The predetermined format messages are stored in a memory device. The RF messages are received at the RF modem from the plurality of transmitting and receiving units via the RF communication system. The RF messages received from the plurality of transmitting and receiving units via the RF communication system are converted to predetermined format messages using the RF modem. The predetermined format messages are stored in the memory device. The RF modem is used to convert the predetermined format messages provided by the PLC modem, and the predetermined format messages are converted to RF messages. The converted RF messages are transmitted to at least one of the plurality of RF transmitting and receiving units using the RF modem. The PLC modem is used to convert the predetermined format messages provided from the RF modem, and the predetermined format messages are converted to PLC messages. The converted PLC messages are transmitted over the power line using the PLC modem.

### BRIEF DESCRIPTION OF DRAWINGS

FIG. 1 is a block diagram view of one exemplary embodiment of a power line communications-radio frequency (PLC-RF) enhanced bridge operating between remote RF transmitting and receiving units and a power line.

FIG. 2 is a block diagram view of one exemplary embodiment of a PLC-RF enhanced bridge.

FIG. 3 is a data structure view of one exemplary embodiment of a message.

FIG. 4 is a data structure view of one exemplary embodiment of a data field of a message.

### DETAILED DESCRIPTION

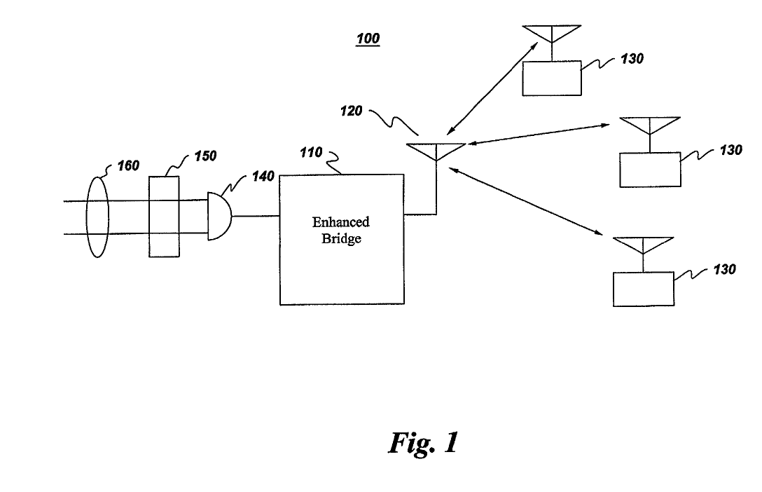

In one embodiment as shown in FIG. 1, a communication system 100 includes a power line communication-radio frequency (PLC-RF) enhanced bridge 110. A connection to a power line 160 is provided from a power receptacle 150. The PLC-RF enhanced bridge 110 comprises a power plug 140 that is inserted into the power receptacle 150, and when an electrical contact is formed, the power line 160 is available to the PLC-RF enhanced bridge 110 as a communications medium. Additionally, as shown in FIG. 1, the PLC-RF enhanced bridge 110 is connected to an RF antenna 120 that can communicate using RF communications with one or more remote RF transmitting and receiving units 130.

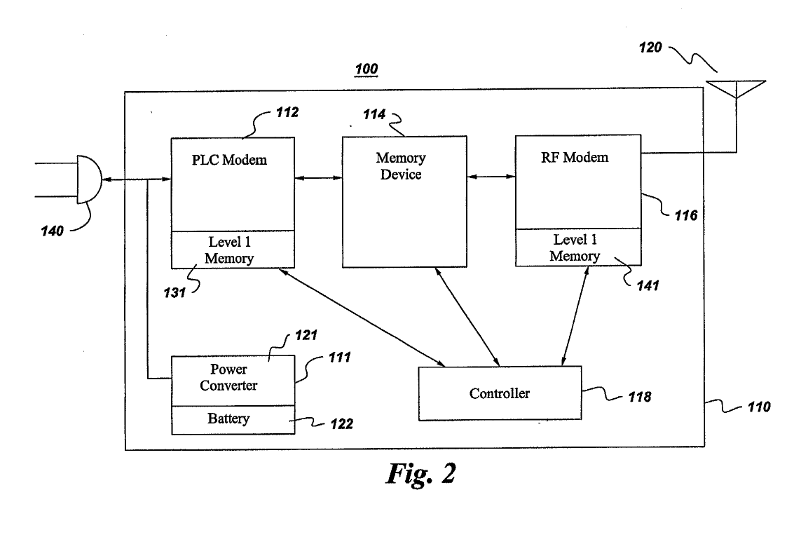

As shown in FIG. 2, the PLC-RF enhanced bridge 110 includes a PLC modem 112 that is connected to a power supply unit 111 and the power plug 140. The PLC modem is also connected to a controller 118 and a memory unit 114. In one embodiment, the memory unit 114 comprises a buffer and/or memory storage, such as, for example, random access memory. In another embodiment, the controller 118 can comprise a computing device, such as, for example, a microprocessor. It should be appreciated that, in other embodiments, the controller 118 can include a memory unit/device (not shown). A radio frequency (RF) modem 116 is connected to the RF antenna 120 and the memory unit 114. The controller 118 is also connected to the memory unit 114 and the RF modem 116. When electrical contact is established between the power line 160 and the power plug 140, the power line 160 has been made accessible as a communication medium with the PLC-RF enhanced bridge 110. In one embodiment, as shown in FIG. 2, the power supply unit 111 includes a power converter 121 for converting the power line voltage to voltages used to operate the PLC-RF enhanced bridge 110. Also shown in FIG. 2, the power supply unit 111 includes a battery 122 that is used to provide power to the PLC-RF enhanced bridge 110 during power interruptions. It should be appreciated that, in another embodiment, the power supply 111 can be individually connected to all the components of the PLC-RF enhanced bridge 110.

As discussed hereinabove, when the power line 160 is electrically connected to the power plug 140, the power line 160 is made accessible as a communications medium. The power plug 140 is also connected to the PLC modem 112 that demodulates PLC messages that are transported via the power line 160. In one embodiment, the demodulated messages are demodulated to a predetermined format message. In another embodiment, the predetermined format messages are at baseband. The PLC modem 112 provides the predetermined format messages to the controller 118. From the controller 118, the baseband messages are sent to the memory unit 114. In one embodiment, the memory unit 114 comprises a buffer and message memory comprising, for example, random access memory (RAM). In another embodiment, the PLC modem 112 provides the predetermined format messages directly to the memory unit 114, and the controller 118 controls the transfer of the predetermined format messages between the PLC modem 112 and the memory unit 114. In even another embodiment, the PLC modem includes a memory 131, and the predetermined format messages are provided to the memory 131 that stores the predetermined format messages before they are transferred to various other components. In one embodiment, the memory 131 comprises, for example, random access memory (RAM). The controller 118 controls the flow of the predetermined format messages that are provided to the RF modem 116 from the memory unit 114. The RF modem 116 also modulates the baseband messages for radio frequency (RF) transmission. The radio frequency (RF) messages are broadcasted by the RF modem from the antenna 120. The RF messages are transmitted to one or more remote RF transmitting and receiving units 130.

In another direction of data flow (radio frequency (RF) to power line communications (PLC)), RF messages transmitted by one or more of the remote RF transmitting and receiving units 130 are received by the antenna 120 of the PLC-RF enhanced bridge 110. In one embodiment, the RF modem 116 demodulates the RF messages to a predetermined format message. In another embodiment, the predetermined format messages are at baseband. Under control of the controller 118, the predetermined format messages are provided to the memory unit 114. The predetermined format messages are read from the memory unit 114 into a PLC modem 112, and the transfer of the predetermined format messages between the memory unit 114 and the PLC modem 112 is also controlled by the controller 118. The PLC modem 112 modulates the baseband messages to a transmission format suitable for transportation on the power line 160. In another embodiment, the predetermined format messages are provided to the controller 118 and then are sent to the memory unit 114 from the controller 118. In even another embodiment, the RF modem 116 includes a memory 141 where the predetermined format messages are stored before being transferred to various other components. In one embodiment, the memory 131 comprises, for example, random access memory (RAM).

In one embodiment, the PLC-RF enhanced bridge 110 links two communication modalities, for example, a power line communications (PLC) system with radio frequency (RF) wireless communication system. The messages transmitted on one communications modality are received at the PLC-RF enhanced bridge 110 and retransmitted to the other modality. In one embodiment, the PLC modem 112 of the PLC communications system can use harmonic modulation (HM). In another embodiment, the RF modem 116 of the RF communications system can use ultra wideband (UWB) signaling. In another embodiment, the RF modem 116 of the RF communication system can use a wireless point to multipoint application, such as, for example, Bluetooth. It should be appreciated that, in this embodiment, the PLC communication system including the PLC modem 112 can be adapted to carry Bluetooth protocols to extend the effective range of the Bluetooth application. The messages are transmitted according to a communications protocol that is segmented into layers. In one embodiment, the lowest layer, layer 1, is referred to as the physical layer. Layer 1 is concerned with communications signaling including, for example, the electrical specifics, timing, etc. In addition, the data link layer is referred to as layer 2 and is used to establish error-free transmission of the messages. Additionally in other embodiments, higher layers of the communication protocol relate to responsibilities, such as, message routing, and message sequencing.

The flow of data through the PLC-RF enhanced bridge 110 is governed by a protocol suite. In one embodiment both the PLC modem 112 and the RF modem 116 perform the physical layer of the protocol stack function (level 1) that encompasses various responsibilities, such as, specifics of bit signaling, sensing clear-to-send states etc. In one embodiment, the protocol stack functions are typically divided into seven layers or levels. The levels are intended to represent divisions between naturally grouped functions. Such groupings of the functions promote standardization and an efficient framework for network architecture. Level 1 of the protocol stack functions is termed the physical layer. In one embodiment, the physical layer is concerned with details that include, such as, for example, the representation of the signaling waveforms of the data element (e.g., bits that are used in the channel between a transmitter and a receiver), link flow characteristics (e.g., whether simultaneous bidirectionality is allowed), establishment and tear-down of initial connection, wiring conventions and timing.

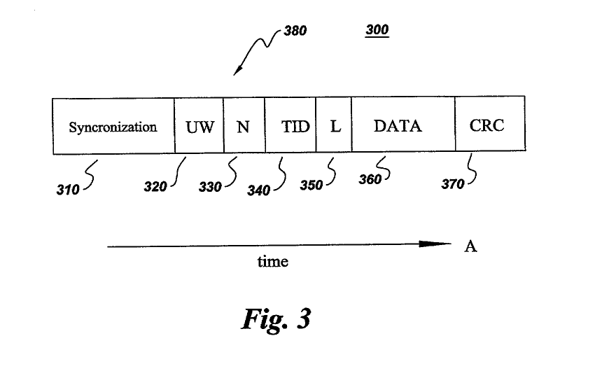

When receiving and demodulating a message 380 (FIG. 3) to a baseband bit stream, the PLC modem 112 and the RF modem 116 send demodulated bits to the memory unit 114 that buffers the bit stream. The controller 118 examines the received, demodulated bit stream and performs a higher level protocol functions on the bit steam. In one embodiment, the higher level protocol comprises a data link layer protocol that checks to ensure that the received message 380 (FIG. 3) is without error and that appropriate acknowledgments and non-acknowledgments are sent. Once a complete and certified correct message 380 (FIG. 3) has been received from one of the RF modem 116 or the PLC modem 112, the controller 118 passes the message 380 (FIG. 3) to the other of the RF modem 116 or the PLC modem 112 for modulation and transmission.

In one embodiment, the higher level protocol functions of the controller 118 can be locally reprogrammed by a special message inserted in an electrical port (not shown) in the PLC-RF enhanced bridge 110. In another embodiment, the higher level protocol functions of the controller 118 can be remotely reprogrammed by sending a special message to the PLC-RF enhanced bridge 110. It should be appreciated that, in one embodiment, the special message can be sent as a PLC message or an RF message. The higher level protocol stack functions can include levels 2 through 7 of the protocol stack. In one embodiment, level 2 is termed the data link layer and includes, such as, for example, error control procedures to render the physical layer (layer 1) an error free circuit. In another embodiment, the protocol stack functions included in level 2 comprise, for example, acknowledgment/non-acknowledgment (ACK/NAK) agreements where the data packets are requested to be retransmitted if an error is detected in the received packets.

In one embodiment, the PLC modem 112 comprises a microprocessor operating according to a stored program code to perform the level 1 protocol functions. In another embodiment, the stored program code can be replaced or modified locally by a special message inserted in an electrical port (not shown) in the PLC modem 112. In even another embodiment, the stored program code can be replaced or modified remotely by sending a special message to the PLC-RF enhanced bridge 110. It should be appreciated that, in one embodiment, the special message can be sent as a PLC message or an RF message.

In another embodiment, the RF modem 116 can comprise a microprocessor operating according to a stored program code that performs the level 1 protocol stack functions. In even another embodiment, the stored program code can be replaced or modified locally by a special message inserted in an electrical port (not shown) in the RF modem 116. In yet another embodiment, the stored program code can be replaced or modified remotely by sending a special message to the PLC-RF enhanced bridge 110. It should be appreciate that, in one embodiment, the special message can be sent as a PLC message or an RF message.

As shown in FIG. 3, a message format 300 of a message 380 is provided, and time moves in the direction of arrow A. The message format 300 starts with a synchronization preamble 310 that alerts a receiver that a message 380 is about to be transmitted and also aids in receiver clock recovery. In one embodiment, the synchronization preamble 310 is a sequence of alternating logical zeros and ones. In addition, the synchronization preamble 310 can have a different length depending upon different applications. However in one embodiment, the length of the synchronization preamble 310 can depend upon the characteristics of the communications modality/channel and a false alarm/missed alarm probability specifications.

As further shown in FIG. 3, the synchronization preamble 310 is followed by a unique word (UW) 320. In one embodiment, the unique word (UW) 320 is a binary word that exhibits low magnitude sidelobes in a non-cyclical autocorrelation and also has a low magnitude cross-correlation to the synchronization preamble 310. In another embodiment, the unique word (UW) 320 comprises a Barker sequence. Additionally, the unique word (UW) 320 can have a different length depending upon different applications. However in one embodiment, the length of the unique word (UW) 320 can depend upon the characteristics of the communications modality/channel and the false alarm/missed alarm probability specifications. The message format 300 further includes a message sequence number field (N) 330 that contains a sequence number allowing a higher level of the protocol to detect a break in the message stream such as might happen if, for example, a message were lost. In this embodiment, the next field is the TAG identification field (TID) 340 that identifies the particular TAG associated with the packet, such as, where the message 380 is received from or where the message 380 is to be transmitted. After the TAG identification field (TID) 340, a message length field (L) 350 is provided and includes a number specifying the number of bits within the message. After the message length field (L) 350, a data field (DATA) 360 is provided. An error detection field 370 follows the data field (DATA) 360. In one embodiment, the error detection field 370 comprises a cyclic redundancy code (CRC) word, and the CRC is computed over the message sequence number field (N) 330, the TAG identification field (TID) 340, the message length field (L) 350, and the data field (DATA) 360. In another embodiment, the type of CRC that is used depends upon the characteristics of the communication modality/channel and the false alarm/missed alarm probability specifications.

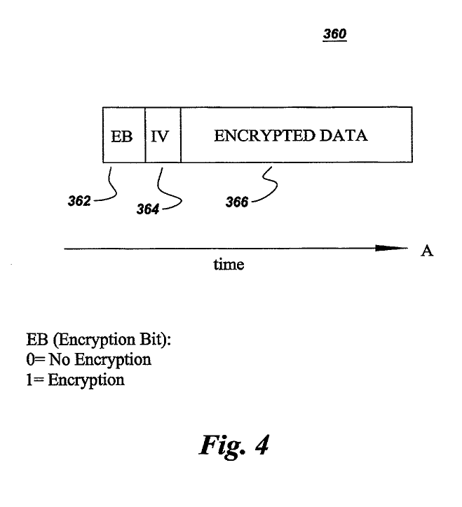

In another embodiment, the PLC-RF enhanced bridge 110 performs additional higher layer protocol functions often performed by a router (not shown). In this embodiment, the PLC-RF enhanced bridge 110 performs protocol conversions between the RF communication system and the PLC communication system. These functions may include decryption of received encrypted messages followed by reencryption under a different keying variable. As shown in FIG. 4 in one embodiment, the DATA field 360 of a message 380 can consist of three parts. The first part is an encryption bit (EB) 362. The second part is an initialization vector (IV) 364. The third part is the encrypted data 366. The initialization vector (IV) 364 governs the initialization of the cryptographic engine that produces the encrypted data 366. When performing a high level protocol function, the controller 118, after successfully receiving a message 380, examines the encryption bit (EB) 362 of the data field (DATA) 360. If the encryption bit (EB) 362 is a zero, the controller 118 considers the remaining bits in the data field (DATA) 360 to be unencrypted data of the message 380. If the encryption bit (EB) 362 is a one, the controller 118 consults a table (not shown) stored in memory (not shown) and retrieves a cryptographic key for the communication modality/channel where the message 380 was transmitted, and the controller 118 uses the cryptographic key and the initialization vector (IV) 364 to decrypt the encrypted message 380.

In another embodiment, the controller 118 buffers the received data 366, and the buffered contents can be rewrapped in new data packets according to priorities programmed into the controller 18 and a state of the individual RF communication links. The state information includes, for example, reliability of delivery, link availability, and link existence. In one embodiment, the controller 118 can be provided with a list of known or vetted RF communication link addresses, and if the controller 118 is requested to forward a message 380 to a non-existent address, the controller 118 is programmed to discard the message rather than transmit the message 380. It should be appreciated that, in one embodiment, the controller 118 selects a signaling rate that is best suited to the state of the individual RF communication link where the message 380 is to be sent.

In another embodiment, the controller 118 can order the messages 380 from a particular RF transmitting and receiving unit 130 before the messages 380 are relayed on the PLC communication system. Some RF transmitting and receiving units 130 can send data 360 in segments in parts that need reassembly at the controller 18. In the process of managing the reliable accumulation and assembly of these segments of data 360, the controller 118 can be programmed to refrain from transmitting the messages 380 that carry the different segments of data 360 until the segments can be re-assembled in order.

The foregoing discussion of the invention has been presented for purposes of illustration and description. Further, the description is not intended to limit the invention to the form disclosed herein. Consequently, variations and modifications commensurate with the above teachings and with the skill and knowledge of the relevant art are within the scope of the present invention. The embodiment described herein above is further intended to explain the best mode presently known of practicing the invention and to enable others skilled in the art to utilize the invention as such, or in other embodiments, and with the various modifications required by their particular application or uses of the invention. It is intended that the appended claims be construed to include alternative embodiments to the extent permitted by the prior art.

1. A dual transceiver enhanced bridge for communicating messages between a radio frequency (RF) communication system and a power line communication (PLC) system, the dual transceiver enhanced bridge comprising:
a PLC modem connected to a power line, the messages being transmitted on and received from the power line using the PLC modem on the PLC communication system;
a memory unit connected to the PLC modem for storing the messages that are transmitted on and received from the power line;
an RF modem connected to the memory unit, the messages being transmitted on and received from the RF modem on the RF communication system; and
a controller connected to the PLC modem, the RF modem, and the memory unit, the controller controlling the transmission and reception of the messages by the RF modem and the PLC modem.

2. The dual transceiver enhanced bridge of claim 1 wherein the PLC modem is connected to the power line by a connecting plug.

3. The dual transceiver enhanced bridge of claim 1 wherein the PLC modem transmits the messages using harmonic modulation (HM) signaling.

4. The dual transceiver enhanced bridge of claim 1 wherein the PLC modem comprises a programmable level 1 protocol stack.

5. The dual transceiver enhanced bridge of claim 1 wherein the RF modem transmits the messages using ultra wideband (UWB) signaling

6. The dual transceiver enhanced bridge of claim 1 wherein the RF modem transmits the messages using a wireless point to multipoint application.

7. The dual transceiver enhanced bridge of claim 6 wherein the wireless point to multipoint application comprises Bluetooth.

8. The dual transceiver enhanced bridge of claim 1 wherein the RF modem comprises a programmable level 1 protocol stack.

9. The dual transceiver enhanced bridge of claim 1 wherein the controller implements protocol stack functions that are above level 1.

10. The dual transceiver enhanced bridge of claim 1 wherein the RF communication system comprises a plurality of RF transmitting and receiving units that communicate messages with the RF modem.

11. The dual transceiver enhanced bridge of claim 10 wherein the RF modem comprises an antenna for transmitting and receiving the messages to and from the plurality of RF transmitting and receiving units.

12. The dual transceiver enhanced bridge of claim 10 wherein the RF modem further comprises a memory device for storing messages received from and transmitted to the plurality of RF transmitting and receiving units via the RF communication system.

13. The dual transceiver enhanced bridge of claim 1 further comprising a power source connected to the power line for powering the dual transceiver enhanced bridge.

14. The dual transceiver enhanced bridge of claim 1 wherein the PLC modem further comprises a memory device for storing messages received from and transmitted over the power line via the PLC system.

15. The dual transceiver enhanced bridge of claim 1 wherein the RF modem further comprises a memory device for storing messages received from and transmitted via the RF communication system.

16. A dual transceiver enhanced bridge for communicating RF messages from a radio frequency (RF) communication system including a plurality of RF transmitting and receiving units and power line communication (PLC) messages from a power line communication (PLC) system, the dual transceiver enhanced bridge comprising:
a PLC modem connected to a power line, the PLC messages being transmitted on and received from the power line using the PLC modem on the PLC communication system wherein PLC modem converts PLC messages received from the power line to predetermined format messages;
an RF modem connected to the PLC modem, the RF modem converts RF messages received from the plurality of RF transmitting and receiving units on the RF communication system wherein the RF modem converts the RF messages to predetermined format message, the PLC modem converts predetermined format messages received from the RF modem to PLC messages before transmission over the power line and the RF modem converts the predetermined format messages received from the PLC modem to RF messages before transmission over the RF communication system;
a memory unit connected between the PLC modem and the RF modem, the memory unit storing predetermined format messages received from the PLC modem and the RF modem;
a controller connected to the PLC modem, the RF modem, and the memory unit,
the controller controlling the transfer the predetermined format messages between the memory unit to the RF modem and the PLC modem.

17. The dual transceiver enhanced bridge of claim 16 wherein the PLC modem is connected to the power line by a connecting plug.

18. The dual transceiver enhanced bridge of claim 16 wherein the PLC modem transmits the PLC messages using harmonic modulation (HM) signaling.

19. The dual transceiver enhanced bridge of claim 16 wherein the PLC modem comprises a programmable level 1 protocol stack.

20. The dual transceiver enhanced bridge of claim 16 wherein the RF modem transmits the RF messages using ultra wideband (UWB) signaling.

21. The dual transceiver enhanced bridge of claim 16 wherein the RF modem transmits the messages using a wireless point to multipoint application.

22. The dual transceiver enhanced bridge of claim 21 wherein the wireless point to multipoint application comprises Bluetooth.

23. The dual transceiver enhanced bridge of claim 16 wherein the RF modem comprises a programmable level 1 protocol stack.

24. The dual transceiver enhanced bridge of claim 16 wherein the controller implements protocol stack functions that are above level 1.

25. The dual transceiver enhanced bridge of claim 16 wherein the RF modem comprises an antenna for transmitting and receiving the RF messages.

26. The dual transceiver enhanced bridge of claim 16 further comprising a power source connected to the power line for powering the dual transceiver enhanced bridge.

27. The dual transceiver enhanced bridge of claim 16 wherein the PLC modem further comprises a memory device for storing PLC messages and predetermined format messages.

28. The dual transceiver enhanced bridge of claim 16 wherein the RF modem further comprises a memory device for storing RF messages and predetermined format messages.

29. The dual transceiver enhanced bridge of claim 16 wherein the predetermined format messages comprise baseband messages.

30. A method for communicating RF messages from a radio frequency (RF) communication system including a plurality of RF transmitting and receiving units and power line communication (PLC) messages from a power line communication (PLC) system, the method comprising the steps of:
connecting a PLC modem connected to a power line;
receiving at the PLC modem PLC messages from the power line via the PLC system;
converting the PLC messages received from the PLC communication system to predetermined format messages using the PLC modem;
storing the predetermined format messages in a memory device;
receiving RF messages at the RF modem from the plurality of transmitting and receiving units via the RF communication system;
converting the RF messages received from the plurality of transmitting and receiving units via the RF communication system to predetermined format messages using the RF modem;
storing the predetermined format messages in the memory device;
using the RF modem to convert the predetermined format messages provided by the PLC modem wherein the predetermined format messages are converted to RF messages;
transmitting the converted RF messages to at least one of the plurality of RF transmitting and receiving units using the RF modem;
using the PLC modem to convert the predetermined format messages provided from the RF modem wherein the predetermined format messages are converted to PLC messages; and
transmitting the converted PLC messages over the power line using the PLC modem.

31. The method of claim 30 wherein the predetermined format messages comprise baseband messages.

32. A method for exchanging power line communication (PLC) messages from a power line communication (PLC) system and radio frequency (RF) messages from a radio frequency (RF) communication system, the method comprising the steps of:
using a PLC modem to receive the PLC messages from a power line connected to the PLC system;
storing the PLC messages in a memory unit;
reading the PLC messages out of the memory unit into an RF modem;
transmitting the PLC messages over the RF communications system using the RF modem;
using the RF modem to receive RF messages from the RF communications system;
storing the RF messages in the memory unit;
reading the RF messages out of the memory unit into the PLC modem; and
transmitting the RF messages over the power line of the PLC communication system using the PLC modem.

33. The method of claim 32 wherein the step of transmitting the PLC messages using the PLC modem uses harmonic modulation (HM) signaling.

34. The method of claim 32 wherein the step of transmitting the RF messages using the RF modem uses ultra wideband (UWB) signaling.

35. The method of claim 32 wherein the step of transmitting the RF messages using the RF modem uses a wireless point to multipoint application.

36. The method of claim 35 wherein the wireless point to multipoint application comprises Bluetooth.
